(19) United States
(12) Patent Application Publication
(10) Pub. No.: US 2020/0399130 A1
(43) Pub. Date: Dec. 24, 2020

(54) METHOD OF PRODUCING CARBON NANOTUBE COMPLEX AND METHOD OF PRODUCING POROUS METAL MATERIAL

(71) Applicant: HITACHI ZOSEN CORPORATION, Osaka-shi, Osaka (JP)

(72) Inventor: Tetsuya INOUE, Osaka-shi, Osaka (JP)

(21) Appl. No.: 16/971,759

(22) PCT Filed: Jan. 25, 2019
(86) PCT No.: PCT/JP2019/002467

§ 371 Date: Aug. 21, 2020

(30) Foreign Application Priority Data
Mar. 1, 2018 (JP) 2018-036666

(51) Int. Cl. C01B 32/166; C01B 32/168

(52) U.S. Cl. CPC C01B 32/166; B82Y 30/00; C01B 32/168

(57) ABSTRACT

A method of producing a carbon nanotube complex includes preparing a mixed solution in which metal is mixed with a solution of a water-soluble polymer, a step of preparing a carbon nanotube assembly that is an assembly of carbon nanotubes extending in a predetermined direction, a step of obtaining an intermediate by impregnating the carbon nanotube assembly with the mixed solution, and a step of causing the carbon nanotube assembly to support the metal and removing the water-soluble polymer by heating the intermediate in an inert atmosphere or a reducing atmosphere. This facilitates the production of a carbon nanotube complex having an orientation.

### TECHNICAL FIELD

The present invention relates to a method of producing a carbon nanotube complex, and a method of producing a porous metal material using the carbon nanotube complex.

### BACKGROUND ART

Composite materials obtained by mixing carbon materials and metal have conventionally been used for purposes such as increasing conductivity, thermal conductivity, or mechanical strength. For example, International Publication WO 2009/038048 (Document 1) proposes a method of producing a transition-metal-coated carbon material by coating the surface of a carbon material with transition metal. In this production method, a compound that contains transition-metal ions, a carbon material, and a dispersion medium are mixed together in a ball mill so that the aforementioned compound is deposited on the carbon material. Alternatively, the aforementioned compound may be deposited on the carbon material by applying an aqueous solution of transition-metal ions to the carbon material and evaporating water, which serves as a solvent. Thereafter, the carbon material is subjected to thermal treatment in a vacuum or an inert atmosphere so as to reduce the transition-metal ions deposited on the carbon material. In Document 1, carbon fibers, carbon nanotubes, carbon nanosheets, and carbon nano yarns are given as examples of the carbon material.

Japanese Patent Application Laid-Open No. 2011-38203 (Document 2) discloses a technique for depositing metal on carbon nanotube fibers by causing the carbon nanotube fibers to pass through a toluene or tetrahydrofuran (THF) solution that contains metal particles or metal ions and to be dried.

The method of mixing a carbon material and a compound in a ball mill as in Document 1 is not suitable for depositing the compound on a carbon nanosheet or a carbon nano yarn. This method is also not suitable for depositing the compound on an assembly of vertically oriented carbon nanotubes. Meanwhile, in the method of applying an aqueous solution of a compound, water serving as a solvent is not likely to penetrate into the interstices between carbon nanotubes. Besides, since the carbon nanotubes coagulate when the water is evaporated after the application of the aqueous solution, the orientations of the carbon nanotubes may deteriorate or disappear. Similarly in Document 2, the orientations of carbon nanotubes may deteriorate or disappear due to coagulation of the carbon nanotubes during evaporation of the solvent.

### SUMMARY OF INVENTION

The present invention is intended for a method of producing a carbon nanotube complex that is an assembly of carbon nanotubes supporting metal, and it is an object of the present invention to facilitate the production of a carbon nanotube complex having an orientation by causing a carbon nanotube assembly to support metal while maintaining the orientation of the carbon nanotube assembly.

A method of producing a carbon nanotube complex according to a preferable embodiment of the present invention includes a) preparing a mixed solution in which metal is mixed with a solution of a water-soluble polymer, b) preparing a carbon nanotube assembly that is an assembly of carbon nanotubes extending in a predetermined direction, c) obtaining an intermediate by impregnating the carbon nanotube assembly with the mixed solution, and d) causing the carbon nanotube assembly to support the metal and removing the water-soluble polymer by heating the intermediate in an inert atmosphere or a reducing atmosphere. This method facilitates the production of a carbon nanotube complex having an orientation.

Preferably, the carbon nanotube assembly prepared in the operation b) includes a plurality of carbon nanotubes arranged in a planar state in a direction generally perpendicular to the predetermined direction.

Preferably, the carbon nanotube assembly prepared in the operation b) is a carbon nanotube sheet formed by pulling a plurality of carbon nanotubes in the predetermined direction, the plurality of carbon nanotubes being arranged in a standing condition in a planar state.

Preferably, the method of producing a carbon nanotube complex further includes, between the operation c) and the operation d), forming a linear carbon nanotube wire by gathering the intermediate of a sheet-like shape in a width direction.

A method of producing a carbon nanotube complex according to another preferable embodiment of the present invention includes a) preparing a mixed-solution film that is a film of a mixed solution containing metal, b) preparing a carbon nanotube assembly in which a plurality of carbon nanotubes extending in a thickness direction of the mixed-solution film are arranged in a planar state in a direction generally perpendicular to the thickness direction, c) obtaining an intermediate in which the carbon nanotube assembly is arranged inside the mixed-solution film, by causing the carbon nanotube assembly to enter into a surface of the mixed-solution film, and d) causing the carbon nanotube assembly to support the metal and removing the mixed solution by heating the intermediate in an inert atmosphere or a reducing atmosphere. This method facilitates the production of a carbon nanotube complex having an orientation.

Preferably, the carbon nanotube assembly prepared in the operation b) includes a carbon nanotube having a surface provided with amorphous carbon.

Preferably, the mixed solution prepared in the operation a) contains salt of the metal as a solute.

Preferably, the mixed solution prepared in the operation a) contains fine particles of the metal.

The present invention is also intended for a method of producing a porous metal material. The method of producing a porous metal material according to a preferable embodiment of the present invention includes preparing the carbon nanotube complex produced by the aforementioned method of producing a carbon nanotube complex, and removing the carbon nanotube assembly by heating the carbon nanotube complex in an oxygen atmosphere.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a side view of a probe card that includes carbon nanotube complexes according to a first embodiment;

FIG. 2 is a perspective view of part of a carbon nanotube complex in enlarged dimensions;

FIG. 3 is a flowchart illustrating the production of carbon nanotube complexes;

FIG. 4 is a side view illustrating the production of carbon nanotube complexes;

FIG. 5 is a side view illustrating the production of carbon nanotube complexes;

FIG. 6 is a side view illustrating the production of carbon nanotube complexes;

FIG. 7 is a side view illustrating the production of carbon nanotube complexes;

FIG. 8 is a side view illustrating the production of carbon nanotube complexes;

FIG. 9 is a side view illustrating the production of carbon nanotube complexes;

FIG. 10 is a flowchart illustrating the production of a porous metal material;

FIG. 11 is a side view of a carbon nanotube complex according to a second embodiment; and

FIG. 12 is a side view of a heat radiating member including carbon nanotube complexes.

### DESCRIPTION OF EMBODIMENTS

FIG. 1 is a side view illustrating a probe card 10 that includes carbon nanotube complexes 1 according to a first embodiment of the present invention. The probe card 10 is a jig used for electrical inspection of a circuit pattern formed on a semiconductor wafer in a system such as a semiconductor wafer inspection system.

The probe card 10 includes a card board 11 and carbon nanotube complexes 1. The card board 11 is a sheet member formed of a resin such as polyimide or silicon rubber. The probe card 10 illustrated in FIG. 1 has a plurality of carbon nanotube complexes 1 arranged thereon in a dot (i.e., lattice) pattern on each of the top and bottom main surfaces of the card board 11. The carbon nanotube complexes 1 pass through the card board 11 and protrude from the top and bottom of the card board 11. The carbon nanotube complexes 1 are probes that are electrically connected to electrode pads of the semiconductor wafer. The carbon nanotube complexes 1 arranged on the top surface of the card board 11 are located at generally the same positions as the carbon nanotube complexes 1 arranged on the bottom surface of the card board 11 in plan view. Each pair of overlapping carbon nanotube complexes 1 on the top and bottom surfaces of the card board 11 in plan view is electrically connected to each other. Each carbon nanotube complex 1 is an assembly of carbon nanotubes 21 supporting metal, and is fixed in a generally vertical position (hereinafter, also referred to as “arranged in a standing condition”) on the card board 11. In the illustration in FIG. 1, the carbon nanotube complexes 1 have a height greater than their actual height.

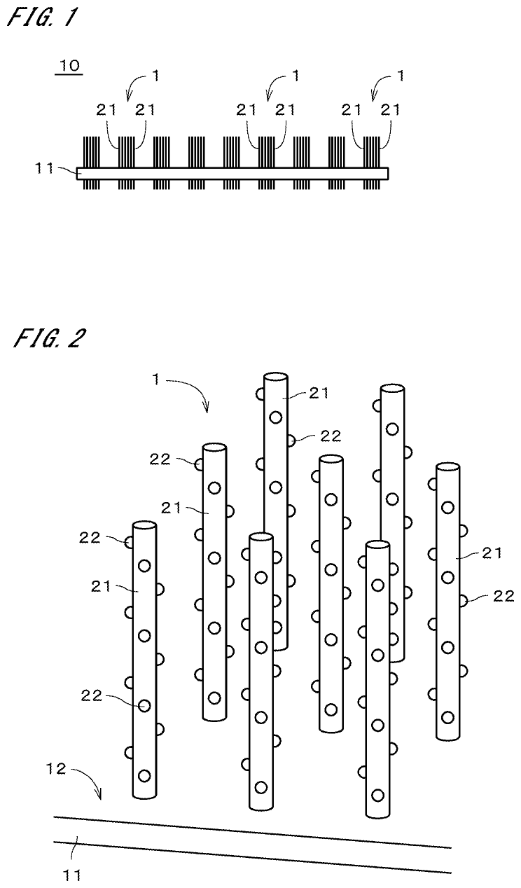

FIG. 2 is a perspective view illustrating part of one carbon nanotube complex 1 in enlarged dimensions. Each carbon nanotube complex 1 includes a plurality of carbon nanotubes 21. The carbon nanotubes 21 of each carbon nanotube complex 1 are arranged in, for example, a generally rectangular or circular shape in plan view. In other words, a region where these carbon nanotubes 21 are arranged has a generally rectangular or circular outside shape in plan view. The outside shape of this region may be changed in various ways.

Each carbon nanotube 21 is arranged on a top surface 12 of the card board 11 while being oriented generally vertically to the top surface 12. Each carbon nanotube 21 is spaced from other adjacent carbon nanotubes 21. In the illustration in FIG. 2, the distance between each pair of adjacent carbon nanotubes 21 is greater than the actual distance. Each carbon nanotube 21 supports metal 22. The metal 22 corresponds to a simple metal substance (e.g., metal atoms) or metal ions. Examples of the metal 22 include copper (Cu), iron (Fe), nickel (Ni), manganese (Mn), zinc (Zn), cobalt (Co), silver (Ag), and gold (Au).

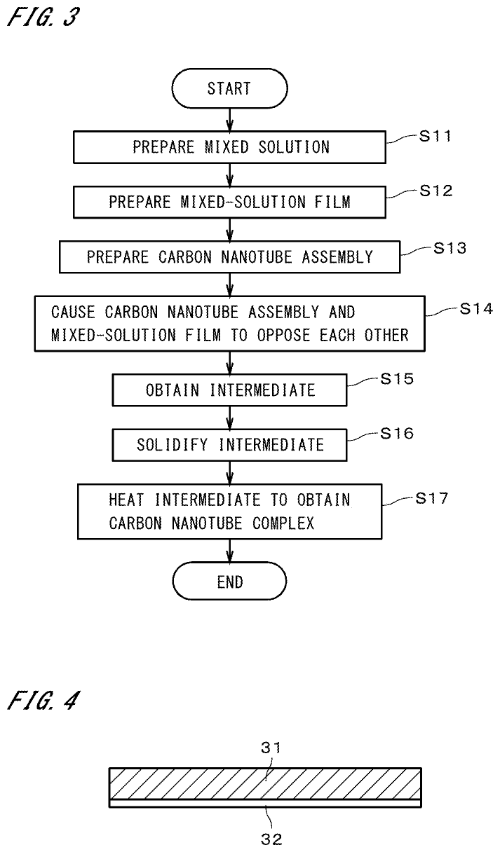

Next, a method of producing carbon nanotube complexes 1 will be described with reference to FIGS. 3 to 9. FIG. 3 is a flowchart illustrating the production of carbon nanotube complexes 1. FIGS. 4 to 9 are side views illustrating the production of carbon nanotube complexes 1.

In the production of carbon nanotube complexes 1, first a mixed solution to be used for the production is prepared (step S11). The mixed solution is a fluid obtained by mixing metal with a solution of a water-soluble polymer. The mixed solution is a pasty (i.e., adhesive) liquid having a relatively high viscosity. The viscosity of the mixed solution is, for example, higher than or equal to 1 mPa·s and preferably higher than or equal to 10 mPa·s. The viscosity of the mixed solution is also, for example, lower than or equal to 5000 mPa·s and preferably lower than or equal to 1000 mPa·s.

The water-soluble polymer may be any of a naturally-occurring polymer, a synthetic polymer, and a semisynthetic polymer. For example, polyvinyl alcohol (PVA) is used as the water-soluble polymer. The concentration of polyvinyl alcohol in the mixed solution is, for example, higher than or equal to 5% by weight and lower than or equal to 15% by weight. A solvent in the mixed solution is, for example, water. The metal contained in the mixed solution is either or both of metal ions and fine metal particles (e.g., fine particles of a simple metal substance or fine particles of a metal oxide). The mixed solution is generated by, for example, dissolving nitrate, sulfate, or sodium chloride of the metal in the solution of the water-soluble polymer. In other words, the mixed solution prepared in step S11 contains salt of the metal as a solute.

Then, a film of the aforementioned mixed solution, i.e., a mixed-solution film, is prepared (step S12). In the example illustrated in FIG. 4, a mixed-solution film 31 is formed on one main surface of a generally flat base material 32. The mixed-solution film 31 is formed by, for example, coating the main surface of the base material 32 to a predetermined thickness with the mixed solution applied to the main surface by doctor blading or any other method. In FIG. 4, the mixed-solution film 31 is cross-hatched in order to facilitate understanding of the drawing. The same applies to the other drawings described later.

Next, assemblies of carbon nanotubes 21 (see FIG. 2) extending in a predetermined direction, i.e., carbon nanotube assemblies, are prepared (step S13). In the example illustrated in FIG. 5, a generally flat generation board 24 has, on its one main surface, a plurality of carbon nanotube assemblies 25 extending in a direction generally perpendicular to the one main surface (i.e., vertically oriented) and formed by chemical vapor deposition (CVD) or any other method. The carbon nanotube assemblies 25 are arranged in a dot pattern on the generation board 24. A plurality of carbon nanotubes 21 included in each carbon nanotube assembly 25 are arranged in a planar state in a direction generally perpendicular to the direction of the orientations of the carbon nanotubes 21. All of the carbon nanotube assemblies 25 have a generally uniform thickness (i.e., height from the main surface of the generation board 24).

Each carbon nanotube 21 included in the carbon nanotube assemblies 25 preferably has a surface provided with amorphous carbon. For example, this amorphous carbon is generated on the surfaces of the carbon nanotubes 21 by changing a heating temperature in the step of generating the carbon nanotubes 21 by CVD.

In the production of carbon nanotube complexes 1, step S13 may be performed before step S11, or may be performed between step S11 and step S12, or may be performed after step S12. As another alternative, step S13 may be performed in parallel with either or both of steps S11 and S12.

When the mixed-solution film 31 and the carbon nanotube assemblies 25 have been prepared, the generation board 24 and the base material 32 are arranged such that the carbon nanotube assemblies 25 and the mixed-solution film 31 oppose each other as illustrated in FIG. 6 (step S14). At this time, in the carbon nanotube assemblies 25, the carbon nanotubes 21 extending in a thickness direction of the mixed-solution film 31 are arranged in a planar state in a direction generally perpendicular to the thickness direction.

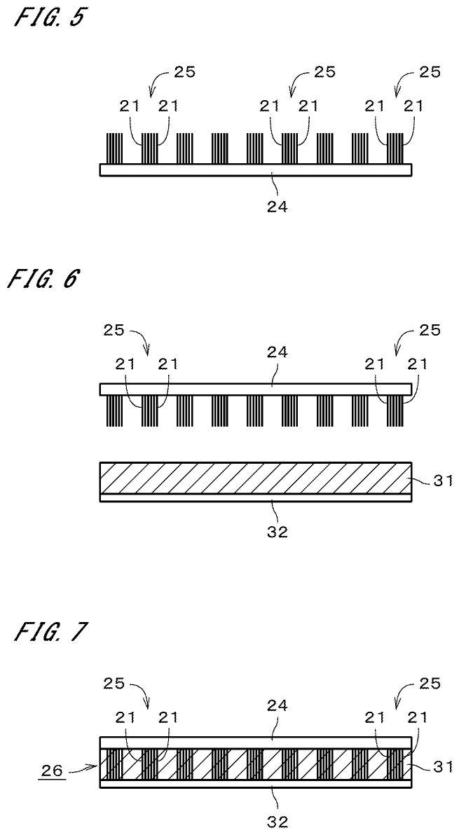

Then, the generation board 24 and the base material 32 are brought close to each other so that the carbon nanotube assemblies 25 enter into the surface of the mixed-solution film 31. In this way, an intermediate 26 is obtained as illustrated in FIG. 7, in which the carbon nanotube assemblies 25 are arranged inside the mixed-solution film 31 (step S15). In the intermediate 26, the orientations of the carbon nanotube assemblies 25 are maintained. In other words, the direction of extension of the carbon nanotubes 21 in the carbon nanotube assemblies 25 (i.e., the direction perpendicular to the surface of the generation board 24) is maintained inside the mixed-solution film 31. The interstices between the carbon nanotubes 21 of the carbon nanotube assemblies 25 are impregnated with the mixed solution. In other words, in step S15, the intermediate 26 is obtained by impregnating the carbon nanotube assemblies 25 with the mixed solution.

When the formation of the intermediate 26 has been completed, the intermediate 26 is dried and solidified (step S16). In step S16, the drying of the intermediate 26 may be accelerated by, for example, heating the intermediate 26, the generation board 24, and the base material 32. For example, the temperature at which the intermediate 26 is heated is in the range of approximately 100 to 150° C. When the intermediate 26 has been solidified, the base material 32 is delaminated and removed from the intermediate 26 as illustrated in FIG. 8. The intermediate 26 is held on the generation board 24.

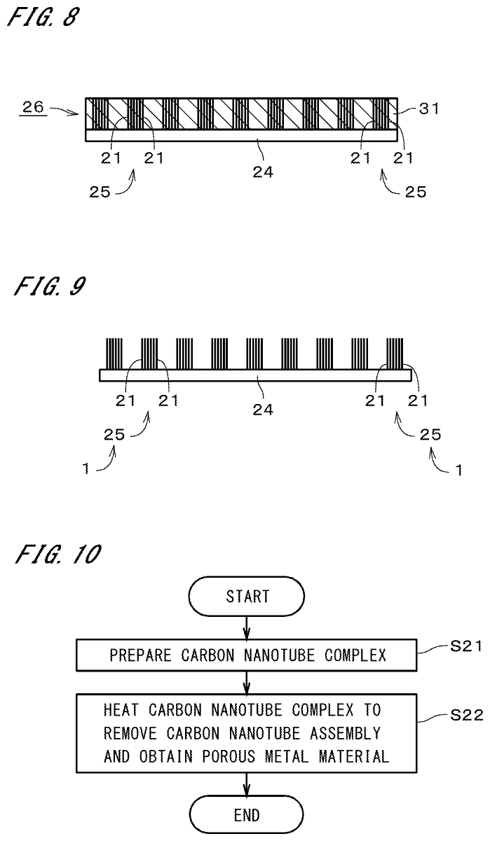

Thereafter, the intermediate 26 and the generation board 24 are transported into a heater and heated in an inert atmosphere or a reducing atmosphere. The atmosphere in the heater is, for example, a nitrogen (N₂) gas atmosphere, an argon (Ar) gas atmosphere, or a hydrogen (H₂) gas atmosphere. As a result of heating the intermediate 26, the water-soluble polymer or other components contained in the mixed solution are removed from the intermediate 26. Also, the metal contained in the mixed solution is deposited on the carbon nanotubes 21 of the carbon nanotube assemblies 25. In other words, as illustrated in FIG. 9, the carbon nanotube complexes 1 supporting the metal 22 (see FIG. 2) are formed from the carbon nanotube assemblies 25 (step S17). The carbon nanotube complexes 1 are delaminated from the generation board 24 and passed through and fixed to the card board 11.

As described above, the method of producing carbon nanotube complexes 1 includes the step of preparing the mixed solution in which metal is mixed with a solution of a water-soluble polymer (step S11), the step of preparing the carbon nanotube assemblies 25 that are assemblies of carbon nanotubes 21 extending in a predetermined direction (step S13), the step of obtaining the intermediate 26 by impregnating the carbon nanotube assemblies 25 with the mixed solution (step S15), and the step of causing the carbon nanotube assemblies 25 to support the metal 22 and removing the water-soluble polymer by heating the intermediate 26 in an inert atmosphere or a reducing atmosphere (step S17).

Since the solution of the water-soluble polymer has a relatively high polarity, the interstices between the carbon nanotubes 21 of the carbon nanotube assemblies 25 can be readily impregnated with the mixed solution containing metal. This facilitates the generation of the intermediate 26. Besides, since the solution of the water-soluble polymer is unlikely to vaporize at room temperature, it is possible to suppress coagulation of the carbon nanotube assemblies 25 involved in the vaporization of the mixed solution, in the intermediate 26 before solidification. Thus, the orientations of the carbon nanotube assemblies 25 are maintained. Moreover, since the solution of the water-soluble polymer has a relatively high viscosity, it is possible to suppress a change in the orientations of the carbon nanotubes 21 in the intermediate 26 before solidification. Accordingly, the orientations of the carbon nanotube assemblies 25 are even more maintained.

In this way, the aforementioned method of producing carbon nanotube complexes 1 allows the carbon nanotube assemblies 25 to support metal while maintaining the orientations of the carbon nanotube assemblies 25. As a result, it is possible to facilitate the production of carbon nanotube complexes 1 having orientations. The carbon nanotube complexes 1 supporting metal can exhibit higher conductivity. This improves the reliability of the probe card 10.

As described above, each carbon nanotube assembly 25 prepared in step S13 includes a plurality of carbon nanotubes 21 arranged in a planar state in a direction generally perpendicular to the aforementioned predetermined direction. The aforementioned method of producing carbon nanotube complexes 1 can suppress coagulation of the nanotubes 21 and is thus in particular suitable for producing the above-described carbon nanotube complexes 1.

In the aforementioned method of producing carbon nanotube complexes 1, the mixed solution prepared in step S11 contains salt of the metal 22 as a solute. This facilitates the mixing of the metal with the mixed solution. Note that the salt of the metal 22 is not limited to sodium chloride, nitrate, or sulfate, and may be any salt other than those mentioned above.

The mixed solution prepared in step S11 may contain fine particles of the metal 22. In this case, it is possible to increase the amount of the metal 22 supported by the carbon nanotube assemblies 25 (hereinafter, referred to as “metal-supporting amount”), irrespective of the solubility of metal salt in the solution of the water-soluble polymer. For example, in the case where the solution of the water-soluble polymer is saturated with metal salt and further mixed with fine metal particles, it is possible to increase the metal-supporting amount of the carbon nanotube complexes 1 to a value greater than a metal-supporting amount that corresponds to the solubility of the metal salt.

In the aforementioned method of producing carbon nanotube complexes 1, the carbon nanotube assemblies 25 prepared in step S13 include the carbon nanotubes 21 each having a surface provided with amorphous carbon. This improves the adhesion of the metal 22 to the carbon nanotube assemblies 25.

In the method of producing carbon nanotube complexes 1, the mixed solution does not necessarily have to contain a water-soluble polymer. In this case, the method of producing carbon nanotube complexes 1 includes the step of preparing the mixed-solution film 31 that is a film of a mixed solution containing metal (step S12), the step of preparing the carbon nanotube assemblies 25 in which a plurality of carbon nanotubes 21 extending in the thickness direction of the mixed-solution film 31 are arranged in a planar state in the direction generally perpendicular to the thickness direction (step S13), the step of obtaining the intermediate 26 in which the carbon nanotube assemblies 25 are arranged inside the mixed-solution film 31, by causing the carbon nanotube assemblies 25 to enter into the surface of the mixed-solution film 31 (step S15), and the step of causing the carbon nanotube assemblies 25 to support the metal 22 and removing the mixed solution by heating the intermediate 26 in an inert atmosphere or a reducing atmosphere (step S17).

The method of producing carbon nanotube complexes 1 can suppress coagulation of the carbon nanotube assemblies 25 by causing the carbon nanotube assemblies 25 to enter into the mixed-solution film 31 having a relatively high viscosity. As a result, in the same manner as described above, the method can cause the carbon nanotube assemblies 25 to support the metal while maintaining the orientations of the carbon nanotube assemblies 25. This facilitates the production of the carbon nanotube complexes 1 having orientations.

From the viewpoint of maintaining the orientations of the carbon nanotubes 21 in the intermediate 26, the viscosity of the mixed solution is preferably higher than or equal to 1 mPa·s and more preferably higher than or equal to 10 mPa·s. From the viewpoint of facilitating the formation of the mixed-solution film 31, the viscosity of the mixed solution is preferably lower than or equal to 5000 mPa·s and more preferably lower than or equal to 1000 mPa·s.

The method of producing carbon nanotube complexes 1 can also facilitate the mixing of the metal with the mixed solution by causing the mixed solution prepared in step S11 to contain salt of the metal 22 as a solute. The method can also increase the metal-supporting amount of the carbon nanotube complexes 1 by causing the mixed solution prepared in step S11 to contain fine particles of the metal 22. Moreover, by causing the carbon nanotube assemblies 25 prepared in step S13 to include the carbon nanotubes 21 each having a surface provided with amorphous carbon, it is possible to improve the adhesion of the metal 22 to the carbon nanotube assemblies 25 and to improve the strengths of both the carbon nanotube assemblies 25 and the carbon nanotube complex 1.

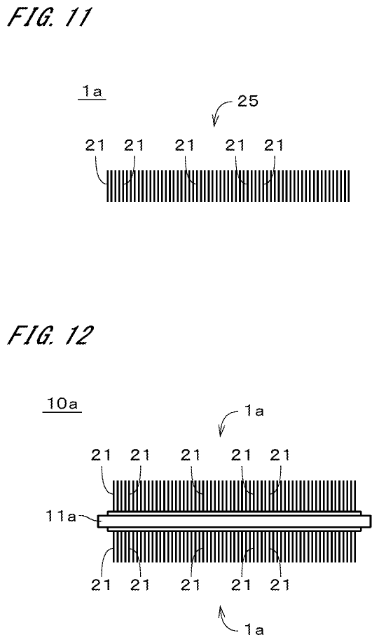

FIG. 10 is a flowchart illustrating a method of producing a porous metal material using the aforementioned carbon nanotube complexes 1. In the production of a porous metal material, first, the carbon nanotube complexes 1 produced by the production method illustrated in FIG. 3 are prepared (step S21). Then, the carbon nanotube complexes 1 are transported into a heater and heated in an oxygen atmosphere (i.e., an atmosphere containing an oxygen gas). Accordingly, the metal 22 supported by the carbon nanotube assemblies 25 is bonded into a metal compact. Moreover, the carbon nanotubes 21 in the carbon nanotube assemblies 25 are oxidized and removed as carbon dioxide or the like from the metal compact. As a result, this metal compact becomes a porous metal material having a large number of pores formed therein by the removal of the carbon nanotubes 21 (step S22).

As described above, the method of producing a porous metal material includes the step of preparing the carbon nanotube complexes 1 produced by the aforementioned method of producing carbon nanotube complexes 1 (step S21) and the step of removing the carbon nanotube assemblies 25 by heating the carbon nanotube complexes 1 in an oxygen atmosphere (step S22). As described previously, the carbon nanotube complexes 1 are formed while mainlining the orientations of the carbon nanotube assemblies 25. Therefore, it is possible, by removing the carbon nanotube assemblies 25 in step S22, to readily obtain a porous metal material with pores having orientations.

Next, a carbon nanotube complex 1a according to a second embodiment of the present invention will be described. FIG. 11 is a side view of the carbon nanotube complex 1a. Like the aforementioned carbon nanotube complexes 1, the carbon nanotube complex 1a includes a plurality of carbon nanotubes 21 and metal 22 supported by each carbon nanotube 21 (see FIG. 2). A porous metal material with pores having orientations can be used as a separation membrane.

Unlike in the example illustrated in FIG. 1, the carbon nanotubes 21 of the carbon nanotube complex 1a are not supported by a support member such as a board and stand independently. That is, the carbon nanotubes 21 included in the carbon nanotube complex 1a are so-called self-standing carbon nanotubes. In the carbon nanotube complex 1a, the carbon nanotubes 21 are arranged in, for example, a generally rectangular or circular shape in plan view. In other words, a region where the carbon nanotubes 21 are arranged has a generally rectangular or circular outside shape in plan view. The outside shape of this region may be changed in various ways.

The procedure for producing the carbon nanotube complex 1a is generally identical to the aforementioned steps S11 to S17 (see FIG. 3), but differs in that not only the base material 32 but also the generation board 24 are delaminated and removed from the intermediate 26 in a step performed between the solidification of the intermediate 26 (step S16) and the removal of the water-soluble polymer (step S17). Therefore, the intermediate 26 heated in step S17 stands independently without being fixed to the support member such as a board. Then, the intermediate 26 is heated in an inert atmosphere or a reducing atmosphere so as to remove the water-soluble polymer and other components from the intermediate 26 and to form the carbon nanotube complex 1a illustrated in FIG. 11.

Like the method of producing carbon nanotube complexes 1, the method of producing a carbon nanotube complex 1a can cause the carbon nanotube assemblies 25 to support the metal while maintaining the orientation of the carbon nanotube assembly 25. As a result, it is possible to facilitate the production of the carbon nanotube complex 1a having an orientation. It is also possible, by producing a porous metal material by the production method using the carbon nanotube complex 1a illustrated in FIG. 10, to readily obtain a porous metal material with pores having orientations.

In the production of the carbon nanotube complexes 1 and 1a, the intermediate 26 does not necessarily have to be formed by causing the carbon nanotube assemblies 25 to enter into the mixed-solution film 31 on the base material 32. The intermediate 26 may be formed by, for example, applying the aforementioned mixed solution directly to the carbon nanotube assemblies 25 arranged in a standing condition on the generation board 24. In this case, the mixed solution applied to the carbon nanotube assemblies 25 may be flattened by a tool such as a scraper or a roller so as to accelerate the impregnation of the carbon nanotube assemblies 25 with the mixed solution. Alternatively, a sheet substance obtained by increasing the viscosity of the mixed-solution film 31 (i.e., a mixed-solution sheet) may be delaminated from the base material 32, and this mixed-solution sheet may be placed on the carbon nanotube assemblies 25 arranged in a standing condition on the generation board 24. In this case, the intermediate 26 is formed as a result of the carbon nanotube assemblies 25 entering into the mixed-solution sheet from the underside.

In the production of the carbon nanotube complex 1a, the intermediate 26 may be formed by, for example, applying the mixed solution directly to the carbon nanotube assembly 25 delaminated from the generation board 24 and standing independently.

In the aforementioned examples, each carbon nanotube assembly 25 includes a plurality of carbon nanotubes 21 arranged in a planar state in a direction generally perpendicular to the direction of the orientation, but the present invention is not limited thereto. For example, each carbon nanotube assembly 25 prepared in step S13 may be a carbon nanotube sheet formed by pulling a plurality of carbon nanotubes 21 in a predetermined pulling direction, the carbon nanotubes 21 being arranged in a standing condition in a planar state. The pulling direction is a direction generally perpendicular to the direction of the orientations of the carbon nanotubes 21 before pulling. In the carbon nanotube sheet, the carbon nanotubes 21 extend in a predetermined direction (i.e., one direction along the main surface of the carbon nanotube sheet).

In this case, a sheet intermediate is formed in step S15 by, for example, applying the mixed solution directly to the carbon nanotube sheet. For example, the mixed solution is applied to either or both of the main surfaces of the carbon nanotube sheet. Then, in step S17, the intermediate is heated in an inert atmosphere or a reducing atmosphere so as to remove the water-soluble polymer and other components from the intermediate and to form a sheet carbon nanotube complex. This allows the sheet carbon nanotube assembly 25 to support metal while maintaining its orientation. As a result, it is possible to facilitate the production of a sheet carbon nanotube complex having an orientation.

Alternatively, after the sheet intermediate has been formed as described above, a linear (i.e., yarn) carbon nanotube wire may be formed by gathering the intermediate in a width direction. The width direction is a direction generally parallel to the main surfaces of the sheet intermediate (i.e., generally parallel to the main surfaces of a carbon nanotube sheet) and generally perpendicular to the pulling direction of the carbon nanotube sheet. Then, in step S17, the carbon nanotube wire is heated in an inert atmosphere or a reducing atmosphere in step S17 so as to remove the water-soluble polymer or other components from the intermediate and to form a wire-like carbon nanotube complex.

In this way, the method of producing a carbon nanotube complex includes the step of forming a linear carbon nanotube wire by gathering a sheet intermediate in the width direction between step S15 (i.e., the step of obtaining the intermediate) and step S17 (i.e., the step of removing the water-soluble polymer). This allows the wire-like carbon nanotube assembly 25 to support metal while maintaining its orientation. As a result, it is possible to facilitate the production of a wire-like carbon nanotube complex having an orientation.

The aforementioned methods of producing carbon nanotube complexes 1 and 1a and the aforementioned method of producing a porous metal material may be modified in various ways.

For example, the water-soluble polymer contained in the aforementioned mixed solution is not limited to polyvinyl alcohol, and may be any other synthetic water-soluble polymer such as a polyacrylic polymer, polyacrylamide, or a polyethylene oxide. As another alternative, the water-soluble polymer contained in the mixed solution may, for example, be a semisynthetic water-soluble polymer such as carboxymethyl cellulose or methylcellulose, or may be a naturally-occurring water-soluble polymer such as starch or gelatin.

The mixed solution prepared in step S11 does not necessary have to contain salt of the metal as a solute if the mixed solution contains metal, and does not also necessarily have to contain fine metal particles.

The carbon nanotube assemblies 25 prepared in step S13 do not necessarily have to have amorphous carbon on the surfaces of the carbon nanotubes 21.

In the method of producing a carbon nanotube complex 1a, sheet intermediates 26 solidified to some extent may be laminated in a direction parallel to the main surfaces (i.e., the thickness direction) before step S17, and then the water-soluble polymer and other components may be removed in step S17. This increases the thickness of the carbon nanotube complex 1a. As another alternative, the thickness of the carbon nanotube complex 1a may be increased by folding sheet intermediates 26 solidified to some extent or rolling up the sheet intermediates 26 into a generally columnar shape, with one main surface facing inward, before step S17, and then removing the water-soluble polymer and other components in step S17.

In the method of producing a carbon nanotube complex 1a, the sheet intermediate may be formed by first forming the intermediate 26 through direct application of the mixed solution to the carbon nanotube assembly 25, which is delaminated from the generation board 24 and stands independently, and then pulling the intermediate 26 in a predetermined pulling direction. As another alternative, a wire-like intermediate may be formed by gathering the sheet intermediate in the width direction.

While, in the example illustrated in FIG. 1, the carbon nanotube complexes 1 have been described for use as probes of the probe card 10 used for electrical inspection of a semiconductor wafer, the carbon nanotube complexes 1 may be used as, for example, probes of a scanning probe microscope. The carbon nanotube complexes 1 and 1a may be used in various applications.

For example, the carbon nanotube complex 1a illustrated in FIG. 11 may be fixed with an adhesive or other means to either or both of the main surfaces of a board formed of metal, for example, and may be used as a thermal interface material (TIM). FIG. 12 is an illustration of a heat radiating member 10a in which carbon nanotube complexes 1a are fixed to the opposite surfaces of a metal board 11a. In this heat radiating member, the carbon nanotube complexes 1a may be fixed to the metal board by a metallic bond between carbon on each carbon nanotube 21 and metal atoms on the metal board. As described above, the carbon nanotube complex 1a exhibits high thermal conductivity because the carbon nanotubes 21 support the metal 22. This improves thermal dissipation properties of the heat radiating member.

The carbon nanotube complex 1a does not necessarily have to be fixed to a board and may be used singly (i.e., in a self-standing condition) as a heat radiating member. In this case as well, the heat radiating member can have improved thermal dissipation properties as described above.

In the production of the carbon nanotube complex 1a, the intermediate 26 may be heated without being delaminated from the generation board 24, and the carbon nanotube complex 1a may be formed in a standing condition generally perpendicular to the generation board 24. This carbon nanotube complex 1a may be used together with the generation board 24 as the aforementioned heat radiating member. In this case as well, the heat radiating member can have improved thermal dissipation properties as described above.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1, 1a Carbon nanotube complex
21 Carbon nanotube
22 Metal
25 Carbon nanotube assembly
26 Intermediate
31 Mixed-solution film
S11 to S17, S21, S22 Step

1-9. (canceled)

10. A method of producing a carbon nanotube complex that is an assembly of carbon nanotubes supporting metal, the method comprising:
a) preparing a mixed solution in which metal is mixed with a solution of a water-soluble polymer;
b) preparing a carbon nanotube assembly that is an assembly of carbon nanotubes extending in a predetermined direction;
c) obtaining an intermediate by impregnating said carbon nanotube assembly with said mixed solution; and
d) causing said carbon nanotube assembly to support said metal and removing said water-soluble polymer by heating said intermediate in an inert atmosphere or a reducing atmosphere.

11. The method of producing a carbon nanotube complex according to claim 10, wherein
said carbon nanotube assembly prepared in said operation b) includes a plurality of carbon nanotubes arranged in a planar state in a direction generally perpendicular to said predetermined direction.

12. The method of producing a carbon nanotube complex according to claim 10, wherein
said carbon nanotube assembly prepared in said operation b) is a carbon nanotube sheet formed by pulling a plurality of carbon nanotubes in said predetermined direction, said plurality of carbon nanotubes being arranged in a standing condition in a planar state.

13. The method of producing a carbon nanotube complex according to claim 12, the method further comprising:
between said operation c) and said operation d), forming a linear carbon nanotube wire by gathering said intermediate of a sheet-like shape in a width direction.

14. The method of producing a carbon nanotube complex according to claim 10, wherein
said carbon nanotube assembly prepared in said operation b) includes a carbon nanotube having a surface provided with amorphous carbon.

15. The method of producing a carbon nanotube complex according to claim 10, wherein
said mixed solution prepared in said operation a) contains salt of said metal as a solute.

16. The method of producing a carbon nanotube complex according to claim 10, wherein
said mixed solution prepared in said operation a) contains fine particles of said metal.

17. A method of producing a carbon nanotube complex that is an assembly of carbon nanotubes supporting metal, the method comprising:
a) preparing a mixed-solution film that is a film of a mixed solution containing metal;
b) preparing a carbon nanotube assembly in which a plurality of carbon nanotubes extending in a thickness direction of said mixed-solution film are arranged in a planar state in a direction generally perpendicular to said thickness direction;
c) obtaining an intermediate in which said carbon nanotube assembly is arranged inside said mixed-solution film, by causing said carbon nanotube assembly to enter into a surface of said mixed-solution film; and
d) causing said carbon nanotube assembly to support said metal and removing said mixed solution by heating said intermediate in an inert atmosphere or a reducing atmosphere.

18. The method of producing a carbon nanotube complex according to claim 10, wherein
said carbon nanotube assembly prepared in said operation b) includes a carbon nanotube having a surface provided with amorphous carbon.

19. The method of producing a carbon nanotube complex according to claim 10, wherein
said mixed solution prepared in said operation a) contains salt of said metal as a solute.

20. The method of producing a carbon nanotube complex according to claim 10, wherein
said mixed solution prepared in said operation a) contains fine particles of said metal.

21. A method of producing a porous metal material, comprising:
preparing the carbon nanotube complex produced by the method of producing a carbon nanotube complex according to claim 10; and
removing said carbon nanotube assembly by heating said carbon nanotube complex in an oxygen atmosphere.

22. A method of producing a porous metal material, comprising:
preparing the carbon nanotube complex produced by the method of producing a carbon nanotube complex according to claim 17; and
removing said carbon nanotube assembly by heating said carbon nanotube complex in an oxygen atmosphere.
